(19) United States
(12) Patent Application Publication
(10) Pub. No.: US 2009/0223438 A1
(43) Pub. Date: Sep. 10, 2009

(54) ANALOG FOUR TIRE PRESSURE GAUGE

(76) Inventor: CLAUDIO R. BALLARD, HUNTINGTON, NY (US)

Correspondence Address: HOWISON & ARNOTT, L.L.P, P.O. BOX 741715, DALLAS, TX, 75374-1715, US

(21) Appl. No.: 12/396,850

(22) Filed: Mar. 3, 2009

Related U.S. Application Data
(60) Provisional application No. 61/034,252, filed on Mar. 6, 2008.

(51) Int. Cl. G01D 13/22

(52) U.S. Cl. 116/301

(57) ABSTRACT

An analog-style display for simultaneously displaying the pressure of four tires of a vehicle includes a circular dial face having a central indicator light, the dial face having four separate zones around the central indicating light, each zone corresponding to a different one of the tires, four pointers each having a first end adjacent the central indicator light extend outward from the first end thereof into different one of the zones and indicia in each of the zones corresponds to different tire pressures wherein a second end of each pointer is movable to different ones of the indicia to indicate the pressure in the tire corresponding to the zone.

### CROSS-REFERENCE TO RELATED APPLICATIONS

This application claims the benefit of U.S. Provisional Application for Patent Ser. No. 61/034,252, filed Mar. 6, 2008, and entitled ANALOG FOUR TIRE PRESSURE GAUGE, the specification of which is incorporated herein in its entirety by reference.

### TECHNICAL FIELD

The following disclosure relates to an analog style display for simultaneously displaying pressures status of all tires of a four wheeled vehicle.

### BACKGROUND

Many modern vehicles typically use a combination of analog-style and digital-style instrumentation display devices to show the value of sensed or measured parameters, i.e., speed, engine RPMs, temperature, fuel level, and other parameters. In many cases, digital-style instrumentation display devices show the value of the sensed/measured parameter directly, displaying a single discreet number that corresponds to the current value of the parameter. Alternatively, analog-style instrumentation display devices show the value of the sensed/measured parameter by moving a pointer, needle or other indicator (collectively “pointer”) within a predetermined range that corresponds to upper and lower measurement limits. Within the predetermined range of motion, the display will include indicia corresponding to different values for the measured parameter. Typically such indicia include numeric values with or without hash marks or similar divisions between the numeric values. In other instances, simple indicator lights are used to indicate relative information, for example, in the case of a temperature gauge, a red indicator may indicate an over temperature condition.

The air pressure maintained in a vehicle's tires is important for a number of reasons. Over or under inflated tires tend to wear faster and may interfere with the vehicle's handling and steering. Generally, under inflated tires result in less than optimal fuel economy. Consequently, many modern vehicles e.g., automobiles and trucks, are equipped with tire pressure sensors. These sensors transmit a value to a digital display or to an indicator light in the instrumentation panel of the vehicle.

However, in the case of a digital display, the operator can only check the pressure condition of a single tire at any time, typically by scrolling through a menu displayed on the digital display. Alternatively, other vehicles use a single indicator light in the instrument panel of the vehicle that is illuminated when the pressure of one of the vehicle tires is out of the desired range. Such indicator lights may not inform the operator of the vehicle of the particular tire that is out of the desired pressure range. Thus, there exists a need for a display that simultaneously shows a vehicle operator the pressure condition of all of the vehicles tires.

### SUMMARY

In one aspect thereof, an analog-style display for simultaneously displaying the pressure of four tires of a vehicle is disclosed. The face includes a central indicator light having separate zones spaced at ninety degree intervals around the central indicating light, each zone corresponding to a different tire on the vehicle. Four pointers, each having a first end adjacent the central indicator light extends outward from the first end thereof into different one of the zones. A light is positioned in each of the zones for displaying a different color corresponding to the pressure in the tire associated with the zone. Each of the zones includes indicia corresponding to different tire pressures wherein the second end of the pointer is movable to different ones of the indicia to indicate the pressure in the tire corresponding to the zone.

In another aspect, an analog-style display for simultaneously displaying the pressure of the tires of a vehicle includes a circular face having a center and separate zones spaced at ninety degree intervals around the center. Each of the zones corresponds to a different one of the tires. A pointer is provided for each zone, each of the pointers having a first end adjacent the center of the face. Each of the pointers extends outward from the first end thereof into different ones of the zones. In one embodiment, the pointers are formed from a light conducting material and a light source is provided for illuminating the pointers. The dial face includes indicia in each of the zones corresponding to different tire pressures with the second end of each pointer movable to different ones of the indicia to indicate the pressure in the tire corresponding to the zone.

In one embodiment, the analog-style display includes a multicolored light source in each of the zones wherein the multicolored light source displays different colors to corresponding to the pressure of the associated tire. The display may further include a lens and a bezel for mounting the lens over the display. In this regard, the lens may be formed entirely from a scratch-resistant synthetic sapphire material.

In another variation, an analog-style display for simultaneously displaying the pressure of the tires of a vehicle includes a circular dial face having a center and separate zones spaced at ninety degree intervals around the center including a left upper zone corresponding to the left front wheel of the vehicle, a right upper zone corresponding to the right front wheel of the vehicle, a lower left zone corresponding to the left rear wheel of the vehicle and a lower right zone corresponding to the right rear wheel of the vehicle. The display includes a pointer for each of the zones, each of the pointers having a first and second end and a pivot point disposed in that zone. Indicia in each of the zones corresponds to different tire pressures with the second end of each pointer being movable to different ones of the indicia to indicate the pressure in the tire corresponding to the zone. A central indicator light may be provide and positioned such that the spaced apart zones are spaced around the central indicating light.

### BRIEF DESCRIPTION OF THE DRAWINGS

For a more complete understanding, reference is now made to the following description taken in conjunction with the accompanying Drawings in which:

FIG. 1 is a front view of an analog-style display according to the present disclosure.

### DETAILED DESCRIPTION

Referring now to the drawings, wherein like reference numbers are used herein to designate like elements throughout, the various views and embodiments of an analog four tire pressure gauge. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

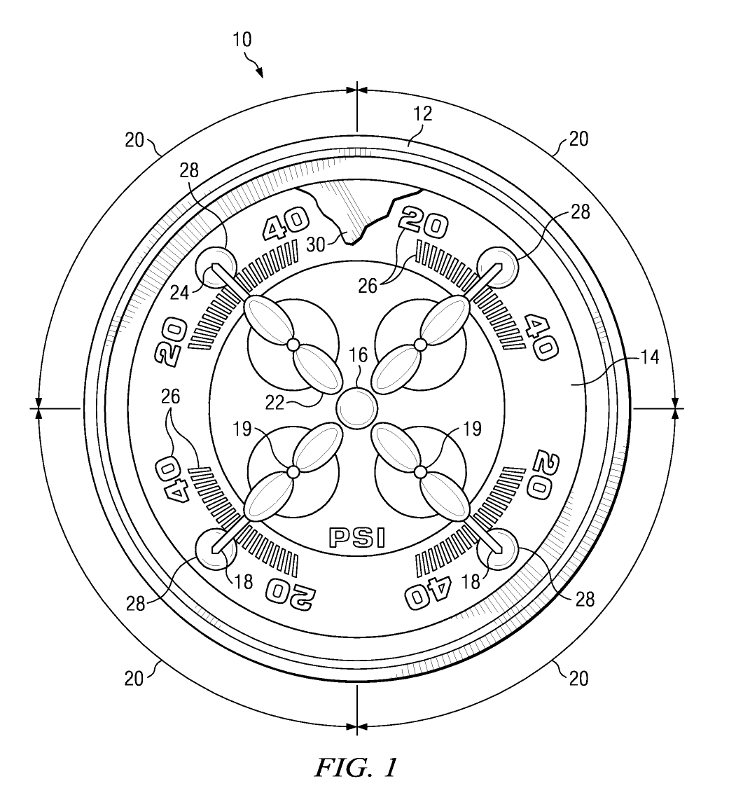

FIG. 1 is a front view of an analog-style display 10 for simultaneously displaying the pressure within the four tires of a vehicle. Display 10 includes a bezel 12, a central indicator light 16 and a plurality of pointers 18. Central indicating light 16 may be one or more light bulbs or LEDs mounted behind face 14. Dial face 14 includes a plurality of quadrants or zones 20 at 90° intervals wherein each of the zones is associated with one of the four wheels of the vehicle.

For intuitive purposes, the left upper zone 20 corresponds to the left front wheel, the right upper zone 20 corresponds to the right front wheel, the lower left zone 20 corresponds to the left rear wheel and the lower right zone 20 corresponds to the right rear wheel of the vehicle. Each of pointers 18 has its own pivot point 19 disposed in a different zone 20 and extending outwardly into a zone 20. In one embodiment, wherein display 10 comprises an analog-style gauge, the pointers 18 have counterweight ends 22 disposed adjacent central indicating light 16 and each pointer 19 is driven by an actuator such as a micro motor or a stepper motor (not shown) positioned behind face 14.

Face 14 of analog-style display 10 includes pressure indicating indicia 26. In the illustrated embodiment the indicia includes the numerals 20 and 40 along with a series of hash marks disposed between the numerals. The outer end 24 of each of pointers 18 is moveable along indicia 26 to indicate the pressure in the associated tire of the vehicle. In order to enhance the visibility of pointers 18, the pointers may be formed from a light conducting material, and illuminated by a light source such as a light bulb or an LED positioned behind face 14 and directed into the transparent base of the pointer.

A zone light 28 is positioned adjacent to indicia 26 in each of zones 20. In one embodiment, the zone light 20 comprises a multicolored LED. In this variation, the multicolored LED displays different colors to indicate the pressure of the associated tire. For example, when the tire pressure is within the correct range, the LED may display a green color. If the tire pressure is low, the LED may display a red or orange color. If the tire pressure is above the desired range, the LED may display a blue color. Similarly, pointers 18 may be illuminated with multicolored LEDs such that the pointer is illuminated with different colors depending on the pressure of the associated tire.

In one embodiment, central indicating light 16 serves to alert an operator of the vehicle to different tire conditions. For example, when all the tires are in the desired pressure range, central indicating light 16 may be illuminated with a green color. If a tire pressure is out of the indicated range, for example if one of the tires is in a low pressure state, central indicating light 16 may flash red. Alternatively, if the pressure in one of the tires is above the indicated or desired pressure range, central indicating light 16 may flash with a blue color. Thus, if an operator of the vehicle does not notice a color change of one of zone lights 28, the flashing central indicator light may draw his attention to the fact that one or more of the vehicle tires needs attention.

In an embodiment where display 10 comprises an analog-style gauge, the gauge may include a lens 30 mounted in bezel 12. Lens 30 may be formed from an appropriate transparent material such as a suitable plastic or glass. In one embodiment lens 30 is formed entirely from a synthetic sapphire material. In this case, lens 30 is more scratch and solvent resistant than alternative materials. Lens 30 may also include an anti-glare coating of the type known in the art.

Display 10 may be embodied as either an analog-type gauge or as part of an electronic flat panel display. Display 10 may have a circular configuration as in the embodiment illustrated in FIG. 1 or another suitable geometry such as rectangular or oblong. In any case, display 10 will have a zone 20 for each individual tire of the vehicle. Preferably zones 20 will be arranged in a fashion corresponding to the position of the tires on the vehicle such that the display is intuitive to an operator of the vehicle. Thus, the operator of the vehicle will, at a glance, be able to determine the pressure status of each of the tires on the vehicle. This is in contrast to typical digital displays in which the pressure of the different tires of the vehicle is displayed numerically for only one of the tires at a time.

It will be appreciated by those skilled in the art having the benefit of this disclosure provides an analog four tire pressure gauge. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An analog-style display for simultaneously displaying the pressure of four tires of a vehicle comprising:
a dial face including a central indicator light, the dial face having four separate zones around the central indicating light, each zone corresponding to a different one of the tires;
four pointers each having a first end adjacent the central indicator light and a second end, each of the pointers extending outward from the first end thereof into different one of the zones; and
indicia in each of the zones corresponding to different tire pressures wherein the second end of each pointer is movable to different ones of the indicia to indicate the pressure in the tire corresponding to the zone.

2. The analog-style display of claim 1 wherein the zones are spaced at ninety degree intervals around the central indicating light.

3. The analog-style display of claim 1 further comprising a light positioned in each of the zones for displaying a different color corresponding to the pressure in the tire associated with the zone.

4. The analog-style display of claim 1 wherein the display has a circular configuration and wherein the display further comprises a lens and a bezel for mounting the lens over the display.

5. The analog-style display of claim 4 wherein the lens is formed entirely from a synthetic sapphire material.

6. The analog-style display of claim 1 wherein the zones are configured corresponding to the position of the tires on the vehicle.

7. An analog-style display for simultaneously displaying the pressure of the tires of a vehicle comprising:
a circular face having a center and separate zones spaced at ninety degree intervals around the center, each zone corresponding to a different one of the tires;
a pointer for each zone, each pointer having a first end adjacent the center of the face, each pointer extending outward from the first end thereof into different ones of the zones; and
indicia in each of the zones corresponding to different tire pressures wherein the second end of each pointer is movable to different ones of the indicia to indicate the pressure in the tire corresponding to the zone.

8. The analog-style display of claim 7 further comprising a central indicator light and wherein the zones are spaced at ninety degree intervals around the central indicating light.

9. The analog-style display of claim 7 further comprising a multicolored light source in each of the zones and wherein the multicolored light source displays different colors corresponding to the pressure of the associated tire.

10. The analog-style display of claim 7 further comprising a lens and a bezel for mounting the lens over the display.

11. The analog-style display of claim 10 wherein the lens is formed entirely from a synthetic sapphire material.

12. The analog-style display of claim 7 wherein the zones are configured corresponding to the position of the tires on the vehicle.

13. The analog-style display of claim 7 wherein the pointers are formed from a light conducting material, and wherein the display further comprises a light source for illuminating the pointers.

14. An analog-style display for simultaneously displaying the pressure of the tires of a vehicle comprising:
a circular dial face having a center and separate zones spaced at ninety degree intervals around the center including a left upper zone corresponding to the left front wheel of the vehicle, a right upper zone corresponding to the right front wheel of the vehicle, a lower left zone corresponding to the left rear wheel of the vehicle and a lower right zone corresponding to the right rear wheel of the vehicle;
a pointer for each of the zones, each pointer of pointers having a first and second end and a pivot point disposed in that zone, each of the pointers and extending outwardly into the corresponding zone; and
indicia in each of the zones corresponding to different tire pressures wherein the second end of each pointer is movable to different ones of the indicia to indicate the pressure in the tire corresponding to the zone.

15. The analog-style display of claim 14 wherein the pointers are formed from a light conducting material, and wherein the display further comprises at least one light source for illuminating the pointers.

16. The analog-style display of claim 14 further comprising a central indicator light and wherein the zones are spaced around the central indicating light.

17. The analog-style display of claim 14 further comprising a multicolored light source in each of the zones and wherein the multicolored light source displays different colors corresponding to the pressure of the associated tire.

18. The analog-style display of claim 14 wherein the pointers are formed from a light conducting material, and wherein the display further comprises a light source for illuminating the pointers.
